(19) United States
(12) Patent Application Publication
(10) Pub. No.: US 2025/0209978 A1
(43) Pub. Date: Jun. 26, 2025

(54) METHODS AND SYSTEMS FOR REDUCING POWER CONSUMPTION IN LOW- POWER AMOLED DISPLAYS USING COLUMN LINE SEGMENTATION

(71) Applicants: Shubham RANJAN, Waterloo (CA); Manoj SACHDEV, Waterloo (CA)

(72) Inventors: Shubham RANJAN, Waterloo (CA); Manoj SACHDEV, Waterloo (CA)

(21) Appl. No.: 18/987,739

(22) Filed: Dec. 19, 2024

Related U.S. Application Data
(60) Provisional application No. 63/613,330, filed on Dec. 21, 2023.

(51) Int. Cl. G09G 3/3225

(52) U.S. Cl. CPC G09G 3/3225; G09G 2310/0281; G09G 2310/0286; G09G 2310/0297; G09G 2310/06; G09G 2330/023

(57) ABSTRACT

Methods and systems for reducing power consumption in an electronic component. The disclosure uses column line segmentation to reduce the power consumption by segmenting the column lines within the electronic component.

### CROSS-REFERENCE TO OTHER APPLICATIONS

The disclosure claims priority from U.S. Provisional Application No. 63/613,330 filed Dec. 21, 2023, which is hereby incorporated by reference.

### FIELD

The disclosure is generally directed at electronic displays and, more specifically, at methods and systems for reducing power consumption in low-power AMOLED displays using column line segmentation.

### BACKGROUND

The daily use of electronic devices continues to grow with individuals relying on their devices to perform daily activities. From looking at weather forecasts to performing financial transactions, humans are becoming more and more reliant on their electronic devices. Regular and consistent use of these electronic devices, more specifically, portable electronic devices, results in a quicker draining of their battery and/or batteries which requires these devices to be more regularly charged. This can be problematic when an individual is not in a location to charge their device. One way to reduce the need for frequent charging is to reduce the power consumption of different components of or applications executing on the portable electronic device.

One component that draws a lot of power, or is a high-power consuming component, is the display. This is problematic when there is a limited battery size powering the portable electronic device. Also, there is a larger intrinsic capacitive load of column, or data, lines when the display is operating with a higher resolution. Another problem with current displays is that there is an increased dynamic power consumption with the increase in the resolution or refresh rate of the display.

Therefore, there is provided novel methods and systems for reducing power consumption in a low-power AMOLED display using column line segmentation.

### SUMMARY

The disclosure is directed at methods and systems for reducing the power and/or energy consumption of electronic displays, more specifically, low-power AMOLED displays. In some embodiments, the disclosure is directed at reducing power and/or energy consumption in portable electronic device displays such as, but not limited to, microdisplays for Near To Eye (NTE) applications, cell phones, tablets, and laptop computers where there is limited energy or power stored on a battery of the portable electronic device. The disclosure includes different embodiments of column capacitance reduction techniques that reduce the dynamic power consumption of the column drivers within AMOLED displays.

In order to improve the battery life of a portable electronic device, it is beneficial to decrease the power consumption of the display, since the display contributes to a significant portion of the total power consumption in many portable electronic devices.

In one embodiment of the disclosure, within the display circuit, row drivers repeatedly and sequentially scan all rows in the display one at a time while the data on the data, or column line is updated based on the pixel value. Each column line is connected to the source of hundreds of access transistors and each of them contributes a capacitance to the column line. Therefore, the net capacitance of the column increases linearly by the number of rows in the display. As each row is scanned, these columns with high capacitance keeps toggling between ‘data 1’ and ‘data 0’, causing significant amount of dynamic power consumption.

In one aspect of the disclosure, there is provided an electronics component having N row lines and M column lines including at least one column driver for driving the M column lines; and at least one row driver for driving the N row lines, wherein the N rows are segmented into a set of column line segments for each of the M column lines; each of the column line segments including an equal number of rows.

In another aspect, each of the column line segments in a column line is connected to at least one other column line segment via a column line segment connector switch. In a further aspect, the electronics component further includes two column drivers for driving two column line segments wherein the column line segments each include N/2 row lines. In yet another aspect, the electronic component further includes two column segment switches, each switch associated with one of the two column drivers. In yet a further aspect, the electronics component includes two sets of row drivers, each of the two sets of row drivers driving the rows in one of the two column line segments.

In another aspect, the electronics component is a two-port memory cell. In an aspect, the electronics component further includes a set of SRAM cells connected to each intersection between a row line and a pair of column lines. In yet another aspect, the at least one column driver includes a combination multiplexor and sense amplifier. In a further aspect, each of the two column line segments are further separated into a set of smaller column line segments. In yet a further aspect, each of the set of smaller column line segments are connected to each other via a set of column line segment connector switches. In another aspect, the electronics component further includes a pair of column line control switches, each of the column line control switches connected to one of the two column line segments.

In another aspect, the electronic component includes a global column line; and a set of global line column line connector connecting each of the column line segments to each other and to the global column line. In another aspect, the at least one column line driver includes a column line shift register; and a column line hold register. In a further aspect, the at least one row driver includes a row shift register. In another aspect, the electronics component is an AMOLED display. In a further aspect, the electronics component further includes a set of pixels connected to each intersection between a row line and a column line.

### BRIEF DISCLOSURE OF THE DRAWINGS

Some embodiments of the present disclosure are illustrated as an example and are not limited by the figures of the accompanying drawings, in which like references may indicate similar elements and in which:

FIG. 1a is a schematic diagram of a prior art N*M AMOLED display;

FIG. 1b is a timing diagram of the display of FIG. 1a;

FIG. 2a is a schematic diagram of first embodiment of a N*M AMOLED display with a power consumption reduction apparatus;

FIG. 2b is a timing diagram of the display of FIG. 2a;

FIG. 3a is a schematic diagram of another embodiment of a N*M AMOLED display with a power consumption reduction apparatus;

FIG. 3b is a timing diagram of the display of FIG. 3a;

FIG. 4a is a schematic diagram of a further embodiment of a N*M AMOLED display with a power consumption reduction apparatus;

FIG. 4b is a timing diagram of the display of FIG. 4a;

FIG. 5a is a schematic diagram of yet another embodiment of a N*M AMOLED display with a power consumption reduction apparatus;

FIG. 5b is a timing diagram of the display of FIG. 5a;

FIG. 6a is a schematic diagram of another embodiment of a N*M AMOLED display with a power consumption reduction apparatus;

FIG. 6b is a timing diagram of the display of FIG. 6a;

FIG. 7a is a schematic diagram of another embodiment of a N*M AMOLED display with a power consumption reduction apparatus; and

FIG. 7b is a timing diagram of the display of FIG. 6a.

### DETAILED DESCRIPTION OF THE EMBODIMENTS

The disclosure is directed at methods and systems for reducing the power and/or energy consumption of portable electronic device displays.

In the disclosure, different embodiments of power consumption reduction apparatus for implementation within a display or electronic component are disclosed. Some embodiments may include at least one of a column line segmentation power consumption reduction methodology or apparatus; a dual column line driver power consumption reduction methodology or apparatus; a dual column line and row line drivers power consumption reduction methodology or apparatus; a dual column line driver with column segmentation power consumption reduction methodology or apparatus and/or a global-local column line segmentation power consumption reduction methodology or apparatus.

In the column segmentation, dual column line driver, dual column line and row line drivers, and dual column line driver with column segmentation embodiments, the embodiments reduce the effective column line capacitance that is charged and discharged during row scanning and therefore, there is less energy required or consumed from the power supply. These embodiments may be used for any driving method and any pixel circuit for an AMOLED display.

Besides, low power displays, the dual column driver-based column line segmentation embodiment may also be used to implement a two port SRAM memory. The dual column driver methodology may be used to replace a two port SRAM memory with a conventional single port 6T SRAM memory, where dual columns can be operated independently—one is performing a read operation while the second one is performing a simultaneous write operation. Such an arrangement reduces the SRAM cell area by 31%, without significant increase in peripheral circuit area.

In some embodiments, the disclosure lowers the power consumption in portable electronic device displays by reducing the dynamic power consumption of the column line drivers. In other embodiments, the disclosure lowers the power consumption in portable electronic device displays by column segmentation. In other embodiments, the disclosure lowers the power consumption in portable electronic device displays by using dual column drivers. In other aspects, the disclosure lowers the power consumption in portable electronic device displays by using dual column drivers together with column segmentation. In other embodiments, the disclosure lowers the power consumption in portable electronic device displays by lowering the clock frequency in PWM schemes by using dual column drivers. In yet other embodiments, the disclosure lowers the power consumption in portable electronic device displays by lowering two port SRAM memory area by using dual column scheme with conventional 6T SRAM memory.

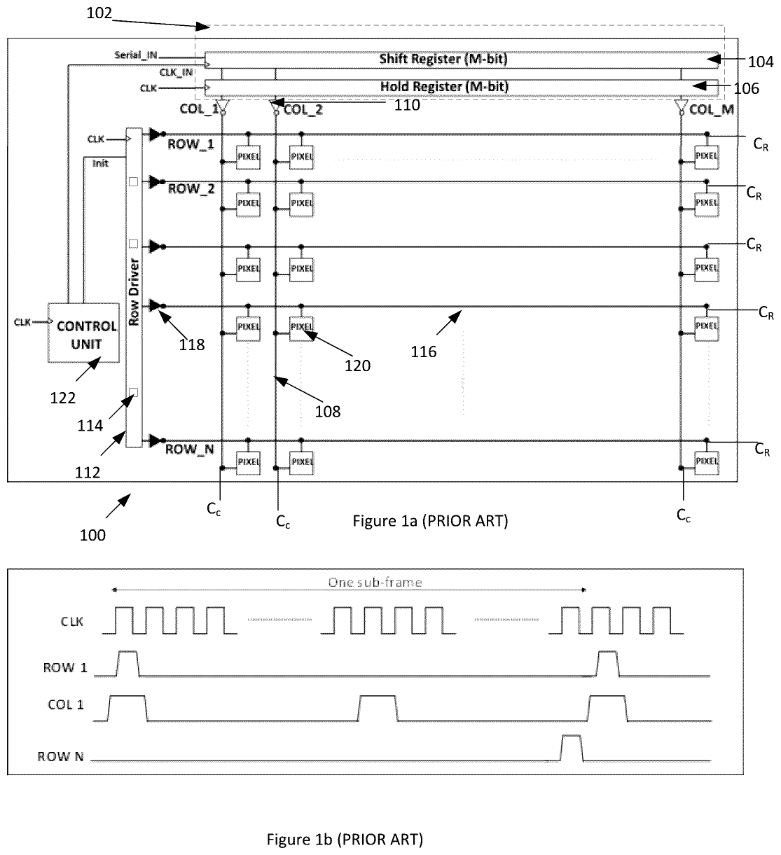

Turning to FIG. 1a, a schematic diagram of a prior art N*M AMOLED display along with peripheral circuitry is shown. The display 100 includes a column driver 102 which includes a shift register 104 and a hold register 106, both of size M, for driving a set of column, or data, lines 108. A set of column, or data, line buffers 110, with one data line buffer 110 associated with one of the set of data lines 108, is responsible to charge and discharge the data lines 108 with proper data values. The display 100 further includes a row driver 112, of size N, including at least one shift register 114 that enables a set of rows, or row lines, 116, one row at a time, via a set of row buffers 118 with one of the set of row buffers 118 associated with one of the set of rows 116.

The display 100 further includes a set of pixels 120, each of the pixels associated with an intersection between one of the set of rows 116 and one of the set of data, or column, lines 108. A combination of the parasitic capacitance of interconnects associated with a row line and the gate capacitance of the pixels or pixel circuits in a row 116 may be represented by a total capacitance, Cr, for each row. The gate capacitance of the pixel circuits may be a nonlinear capacitor which changes with the voltages applied to the access transistor's terminals. Similarly, a total capacitance, Cc, for each column line includes a parasitic capacitance of the column line interconnects and the nonlinear capacitance of the drain/source of the access transistor associated with the column line. The display 100 further includes a signal generator block, or control unit, 122 that generates control signals required for the operation of the column driver 102 and/or the row driver 112.

In one embodiment, the signal generator 122 produces a fast clock signal (Clk_IN) for the column, or data, driver's shift register 104 and an Init signal to initialize scanning by the display 100. In a digital driving scheme, each frame time is sub-divided into multiple sub-frames depending upon colour depth and a pulse width modulation (PWM) scheme. FIG. 1b shows the timing diagram of one sub-frame programming time using a PWM driving scheme.

To write a new pixel value, the set of row lines 116 are scanned sequentially. During each row scan, every column line is loaded with data that is to be stored. In other words, if the new data value for the data line is different than the previous data value stored in the data line or pixel, the new data value is to be stored on the data line when the corresponding row for the pixel is stored or updated so that the pixel associated with the intersection of the row and column is updated.

To load new data in each column line, the buffer of that column line charges the column capacitor (Cc) to VDD via the PMOS transistor (if pixel data of a column goes from “0” to “1”) or it discharges the energy to ground via the NMOS transistor of the buffer (if pixel data of a column goes from “1” to “0”). The size of the Cc capacitor is proportional to the resolution and pixels per inch (PPI), or number of pixels on a column. A higher Cc results in higher dynamic power consumption by the column driver.

Currently, many commercial displays demand a higher refresh rate, higher resolution, and higher pixel per inch (PPI) to improve image quality. Improving these features leads to a higher capacitance per row line and per data line or a higher frequency of operation in the display and as a result a higher dynamic power consumption of the display's driver. The disclosure is directed at a method and system for decreasing dynamic power consumption for a display or display circuit. In other embodiments, the disclosure may also be implemented for other electronic components.

To reduce the dynamic power consumption of the column driver, in one embodiment, the disclosure is directed at a column segmentation methodology to reduce the effective column line capacitance (Cc) that needs to be charged/discharged during each row scan.

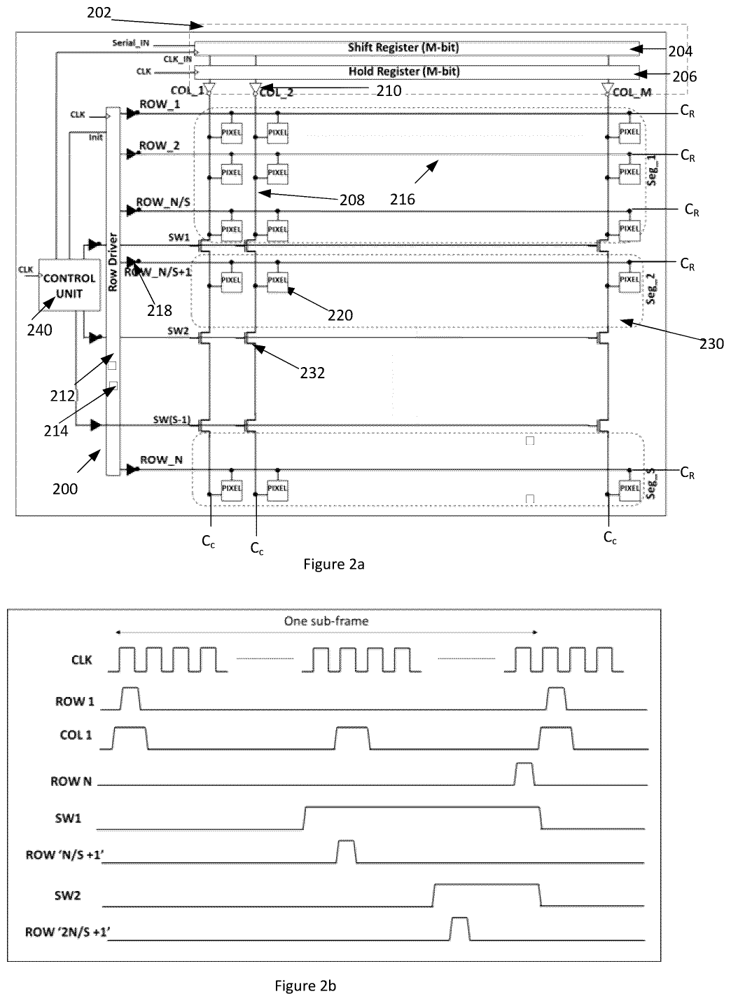

Turning to FIG. 2a, a schematic diagram of an N*M AMOLED display including a column segmentation power consumption reduction apparatus is shown. The display 200 includes a column driver 202 which includes a data line shift register 204 and a data line hold register 206, both of size M, for driving a set of data, or column, lines 208. In the current embodiment, a set of data line buffers 210, with one data line buffer 210 associated with one of the set of data lines 208, is responsible to charge and discharge each of the column lines 208 with proper data values.

The display 200 further includes a row driver 212 including a row line shift register 214 of size N that enables a set of rows 216, one row at a time, via a set of row buffers 218. In one embodiment, one of the set of row buffers 218 is associated with one of the set of rows 216. A combination of the parasitic capacitance of the interconnects associated with the row line 216 and the gate capacitance of pixels or pixel circuits 220 in a row or row line may be represented by a total capacitance, Cr, or stored in a capacitor, Cr, for each row. The gate capacitance of each pixel 220 may be stored in a nonlinear capacitor which changes with the voltages applied to the access transistor's terminals. Similarly, a total capacitance, Cc, for each column line includes a parasitic capacitance of the column line interconnects and the nonlinear capacitance of the drain/source of the access transistor may be stored in a capacitor Cc.

In the current embodiment, each of the data, or column, lines are divided into “S” different segments 230, identified as Seg_1, Seg_2 . . . Seg_S, whereby each segment includes the same number of rows. In other words, for the current embodiment, each segment 230 includes N/S rows. It is assumed that N is divisible by S such that there are an equal number of rows in each segment. Each of the segments 230 is connected to another segment via a set of column line segment connector switches 232. As can be seen in FIG. 2a, SW1 is connected between the last row of Seg_1 and the first row of Seg_2 for each of the column lines. Similarly, SW(S−1) is connected between the last row of Seg_S−1 and the first row of Seg_S. For the current embodiment, although shown as being connected to an adjacent segment, it is understood that in some implementations, the switches may connect the last row of any segment and the first row of another segment. In the current embodiment, the switches 232 are NMOS switches, although other types of switches such as, but not limited to, PMOS or transmission gates are contemplated.

In the current embodiment, the set of data lines is divided into the “S” equal segments 230 and connected by “S−1” NMOS switches 232. For each of the data lines, a source of the first switch SW1 is connected to segment 1 (Seg_1) and a drain of switch SW1 is connected to segment 2 (Seg_2). A gate of all the first switches is connected to the NMOS switch signal across the row. Similarly, the second switch (SW2) connects the second (via the source of SW2) and third segments (via the drain of SW2) of all the data lines through the SW2 signal, and so on. The display 200 further includes a signal generator or control unit 240 that generates the signals for operation of the row driver as well as all segment switches.

FIG. 2b provides a timing diagram for the display of FIG. 2a over a sub-frame programming time or time period. As discussed above, a programming time may be seen as a cycle for the display and the sub-frame represents a portion of that programming time or programming cycle.

As discussed above with respect to FIG. 2a, the size of the display is N rows×M columns whereby the individual column or data lines are divided into ‘S’ equal segments with each segment containing “N/S” rows. Although it appears that the rows are being segmented, it is the column lines that are being segmented to include the rows that connect with the column line in the different segments.

As the row scan starts from the first row, all switches 232 are initially off. Therefore, during the scanning of rows in the first segment, only the capacitance associated with the first segment is charged/discharged. Switch SW1 is enabled only after the rows in the first segment (Seg_1) have been completely scanned i.e., after the scanning of row “N/S”. During the scanning of the rows or row lines in segment 2 (Seg_2), the SW1 switches remain on while all other switches remain off. When scanning of all the rows in segment 2 (Seg_2) has been completed, the SW1 is kept on while SW2 is also turned on before scanning of the rows in segment 3 (Seg_3) is initiated. This procedure repeats for entire row scans during a sub-frame time in the display for all of the segments.

The dynamic power of each data driver is directly proportional to the column capacitance it is charging/discharging whereby the effective capacitance for each segment is smaller than the column capacitance for a whole data line. This results in a reduction of the dynamic power consumption of the column driver within the display of FIG. 2a.

Experiments to test the display of FIG. 2a were performed by simulating the column segmentation technique on a VGA display in TSMC 65 nm technology with a refresh rate of 60 Hz and a PWM driving method. In the experiments, considering the power consumption needed to generate the control signals, the overall dynamic power consumption of the column driver of FIG. 2a was reduced by 27.65% on average for different test images compared with the power consumption of a conventional display. The average backplane dynamic power consumption for different test images using the column segmentation power consumption reduction apparatus of FIG. 2a was reduced by 8.95% with respect to a conventional display.

Applying the technique on a display with a higher resolution, PPI and refresh rate resulted in a higher percentage reduction in the overall (static and dynamic) power consumption. Because the ratio of dynamic power consumption to static power consumption is higher in those displays, reducing the dynamic power consumption has a higher significance on overall power consumption.

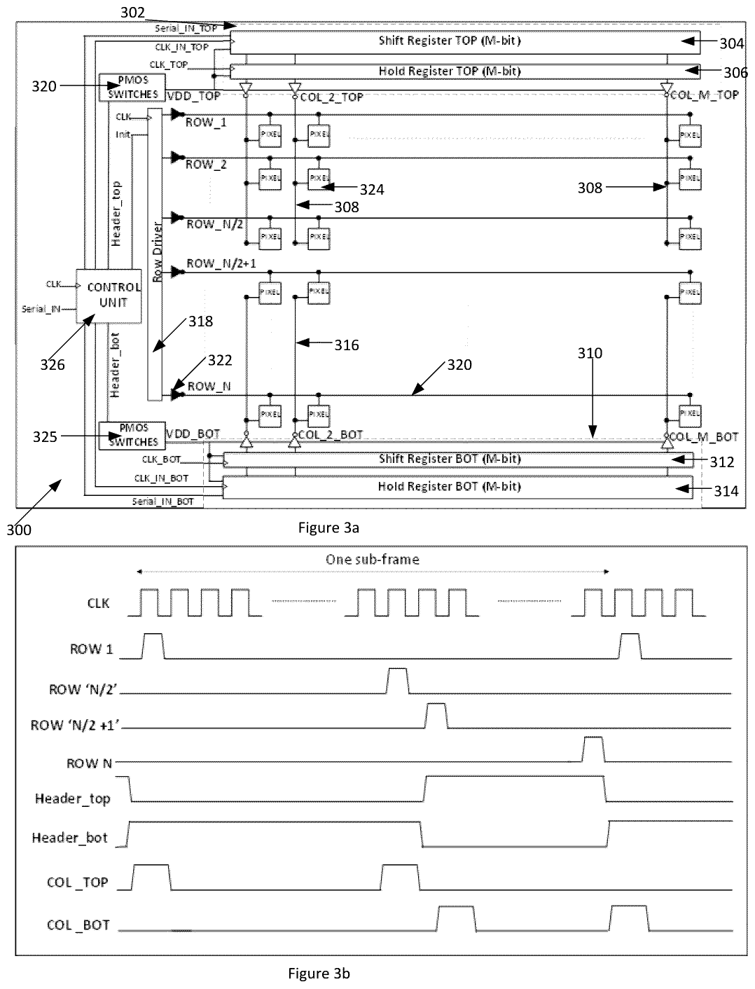

Turning to FIG. 3a, another embodiment of a display including a power consumption reduction apparatus is shown. The embodiment of FIG. 3a may be seen as a dual column line driver embodiment or methodology. The N*M AMOLED display 300 includes a first data, or column, line driver 302 that includes a first shift register 304 and a first hold register 306 that drive a first set of data, or column, lines 308 and a second data, or column, line driver 310 that includes a second shift register 312 and a second hold register 314 that drive a second set of data lines 316. A row driver 318 driving the row lines 320 via a set of row line buffers 322 is also located within the display 300. The display 300 further a set or array of pixels 324 that are associated with an intersection between a row line 320 and each data line in the first set of data lines 308 or second set of data lines 316. The display 300 further includes a pair of column line control switches 320 and 325 (which may be PMOS switches) that control the VDD power connection of each of the data drivers or column drivers in the 302 and 310. If a row line in the top half is accessed, the bottom PMOS switches are turned off which saves or reduces static leakage from the bottom column line drivers, the bottom hold registers and the bottom shift registers. A signal generator, or control unit 326, generates and transmits the signals necessary for operation of the display 300.

In the current embodiment, each data, or column, line is divided into two segments, or halves, driven by the two data, or column, drivers denoted as the first, or top, column driver 302 and the second, or bottom, column driver 310. It is understood in this description that the terms “top” and “bottom” are being used to distinguish between the two different data drivers (and their components) and not to denote an actual physical relationship between these data drivers in a real-world implementation.

A timing diagram depicting operation of the display with the power consumption reduction apparatus of FIG. 3a is shown in FIG. 3b. During the scanning of rows “ROW_1” to “ROW_N/2”, the top data, or column line driver in 302 is activated and drives only the top half of each of the column lines (the top segment). During the scanning of rows “ROW_((N/2)+1)” to “ROW_N”, the bottom data or column driver in 310 is activated and drives only the bottom half of each of the column lines. Therefore, the capacitance of each column line is reduced by half for both the top and the bottom data drivers. To save the static power, the PMOS switches 320 and 325 are used and controlled by individual “header_top” and “header_bottom” signals (generated by the control unit 326 or signal generator) for the top and bottom data drivers, respectively.

If a row line in the top half is being accessed, the bottom PMOS switches are turned off which saves or reduces static leakage power from the bottom data, or column, line drivers, bottom hold registers and bottom shift registers. Similarly, if a row line in the bottom half is being accessed, the top PMOS switches are turned off which saves or reduces static leakage power from top column line drivers, top hold registers and top shift registers.

Experiments to test the display of FIG. 3a were simulated on a VGA display in TSMC 65 nm technology with a refresh rate of 60 Hz and the PWM driving method. Considering the power needed to generate the controlling signals for this technique, the overall dynamic power consumption of the column driver was reduced by 36.07% on average for different test images, and the average backplane dynamic power consumption for different test images using the dual column driver apparatus of FIG. 3a was reduced by 13.38% with respect to a conventional display.

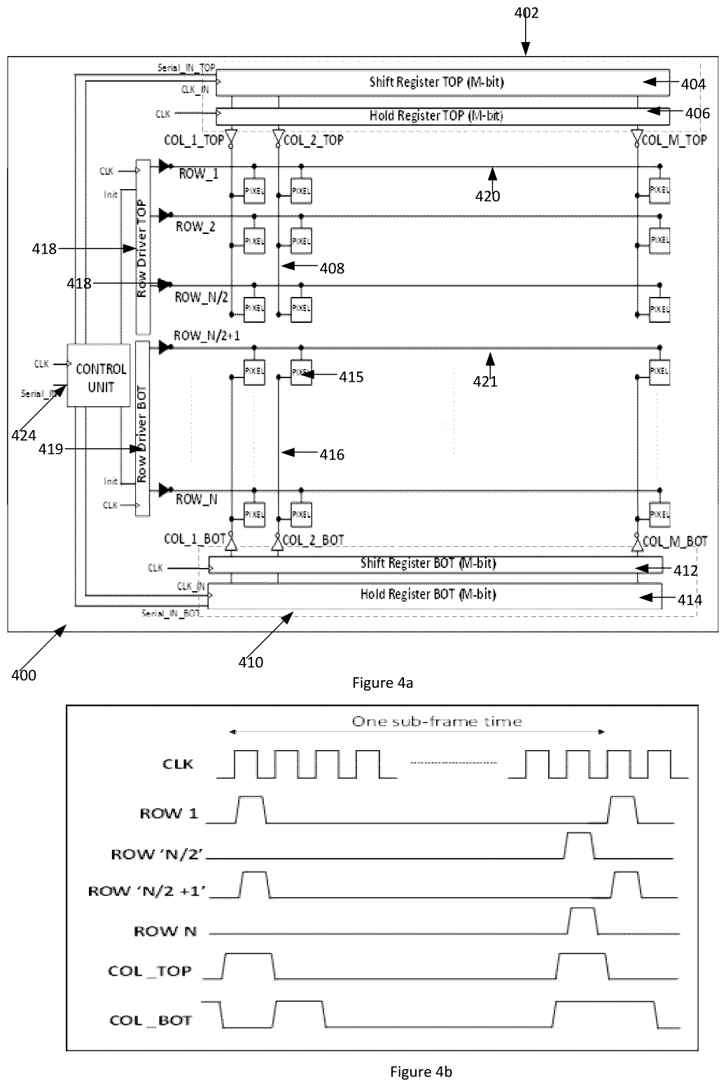

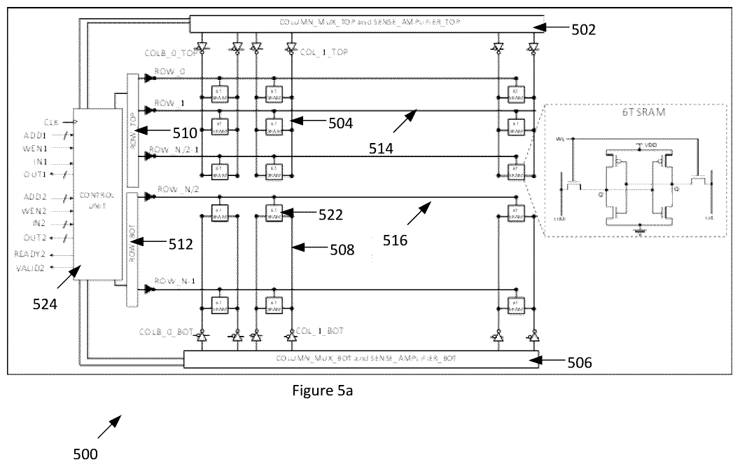

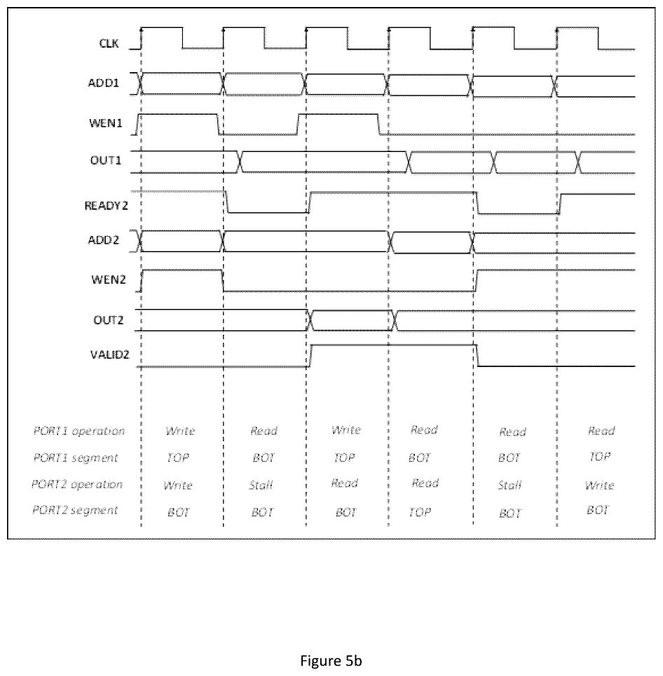

Turning to FIG. 4a, a schematic diagram of another embodiment of a display including a power consumption reduction apparatus via a dual data, or column, line and row line drivers methodology or embodiment is shown. In the embodiment of FIG. 4a, each data or column line is divided into two halves and driven by two column drivers i.e., a top column-driver and a bottom column-driver similar to the embodiment disclosed in FIG. 3a above. The rows are also segmented or separated into different segments as described below.

The N*M AMOLED display 400 includes a first data line driver 402 that includes a first shift register 404 and a first hold register 406 that drive a first set of data, or column, lines 408 and a second data line driver 410 that includes a second shift register 412 and a second hold register 414 that drive a second set of data, or column, lines 416. The display 400 further includes a pair of row drivers 418 and 419 for driving the row lines. Row driver 418 may be seen as a top row driver for driving row lines 420 in a first, or top, section or segment of rows while row driver 419 may be seen as a bottom row driver for driving row lines 421 in a second, or bottom, section or segment of rows. It is understood that row driver 418 and row driver 419 may include more than one row driver for controlling or driving their associated rows. The display 400 further includes a set or array of pixels 415 that are associated with an intersection between a row line 420 and each data line in the first set of data lines 408 or row line 421 and one of the second set of data lines 416. A signal generator 424 for generating signals necessary for the operation of the display is also located within the display 400.

More specifically, row drivers 418 and 419 control the row lines which are divided into two halves with top row driver 418 controlling rows “ROW_1” to “ROW_N/2”, and bottom row driver 419 controlling rows “(ROW_N/2)+1” to “ROW_N”.

In operation, rows “ROW_1” and “ROW_((N/2)+1)” (i.e. the “first” row associated with the top and bottom row drivers) are simultaneously activated by their associated top row driver 418 and bottom row driver 419 and the data is fed through using top column driver and bottom column drivers for “ROW_1” and “ROW_((N/2)+1)”, respectively. Followed by this, rows “ROW_2” and “ROW_((N/2)+2)” are activated simultaneously, and so on until each of the rows have been activated. The timing diagram for operation of this embodiment is shown in FIG. 4b.

In each column, the pixel data from “ROW_1” to “ROW_N/2” is fed through the top column driver while pixel data from “ROW_((N/2)+1)” to “ROW_N” is fed through the bottom column driver. Since two rows are scanned simultaneously, the clock frequency required in this scheme is half compared to conventional display circuits for the same refresh rate.

The power saving achieved in this embodiment is based on two factors: 1) the column capacitance is reduced by half, resulting in lower capacitance and thus lower dynamic power consumption by column driver and 2) the clock frequency is reduced by half, resulting in lower dynamic power consumption as dynamic power consumption is directly proportional to clock frequency.

Testing of the display of FIG. 4a was simulated on a VGA display in TSMC 65 nm technology with a refresh rate of 60 Hz and the PWM driving method. Considering the power consumption needed to generate the controlling signals for this technique, the overall column driver dynamic power consumption was reduced by 36.57% on average for different test images. The average backplane dynamic power consumption for different test images using dual column and row driver scheme was reduced by 13.17% with respect to a conventional display.

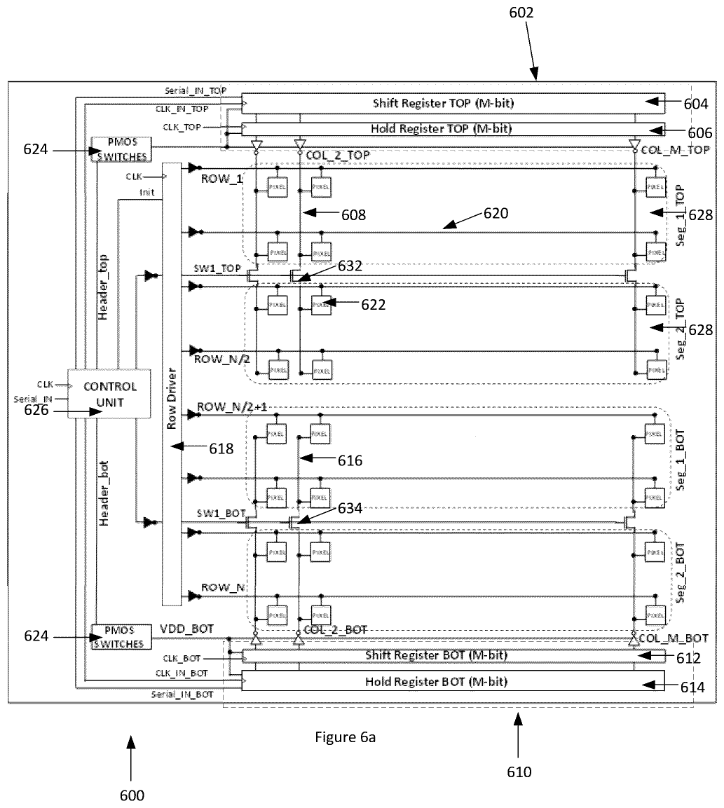

Turning to FIG. 5a, an embodiment of an electronics component with a power consumption reduction apparatus is shown. In the embodiment of FIG. 5a, the power consumption reduction apparatus is implemented via a dual data line driver with column segmentation scheme for 2-port memory using conventional memory. The methodology or embodiment can be used to implement a two port memories using conventional single port memory cells.

The component 500 includes a first, or top, data, or column, line driver 502 that includes a combination multiplexor and sense amplifier that drives a first set of data lines 504 and a second data, or column, line driver 506 (including a combination multiplexor and sense amplifier) that drives a second set of data lines 508. The display 500 further includes a pair of row drivers 510 and 512 for driving a first set of row lines 514 and a second set of row lines 516, respectively. Row driver 510 may be seen as a top row driver while row driver 512 may be seen as a bottom row driver. It is understood that top row driver 510 and bottom row driver 512 may include more than one row driver for controlling the associated rows. The display 500 further includes a set or array of 6T SRAM cell 522 that are associated with an intersection between a row line 514 and column line 504 or row line 516 and column line 508. A signal generator 524 generates the signals necessary for operation of the electronics component 500.

The embodiment of FIG. 5a may be seen as providing a dual column driver power consumption reduction apparatus for implementing a dual port memory. As with the data lines in other embodiments, the different memory cells 522 are divided into two segments i.e., top and bottom. In a first port, the memory accepts an address from the ADD1 bus. If WEN1 (Write enable) is 1, then IN1 (input “1”) data is written at address ADD1 at positive edge of the clock signal. If WEN1 is 0, then data is read from ADD1, and is loaded on an OUT1 bus. Similarly, the second port accepts address information from the ADD2 bus. If WEN2 is “1”, then IN2 is written at address ADD2 at positive edge of the clock signal. If WEN2 is 0, then data is read from ADD2, and is loaded on OUT2 bus and VALID2 is set to 1.

If the top-half/bottom-half segment address (most significant bit (MSB) bit of address) for ADD1 and ADD2 are the same, then the READY2 signal is set to 0. This stalls the operation of port 2 and the VALID2 signal is reset to 0. VALID2 being 0 implies data from port 2 is no longer valid, while READY2 being 0 implies port 2 is not ready to accept a new operation. When the top-half/bottom-half segment address is no longer the same, port 2 resumes normal operation.

The timing diagram for the electronics component in FIG. 5a is shown in FIG. 5b. If the segment address (top half or bottom half) is different, normal, simultaneous read/write operation takes place for both the ports. If the segment addresses are same, operation of the second port is stalled until the address of the first port is different (example in cycle 2 and cycle 5 of FIG. 5b). When port 2 is stalled, the ready signal is reset to 0, implying it does not accept any new operation till the stalled operation is finished. The apparatus of FIG. 5a can be used along with any memory cell and architecture, to speed up the operation without significant impact on area.

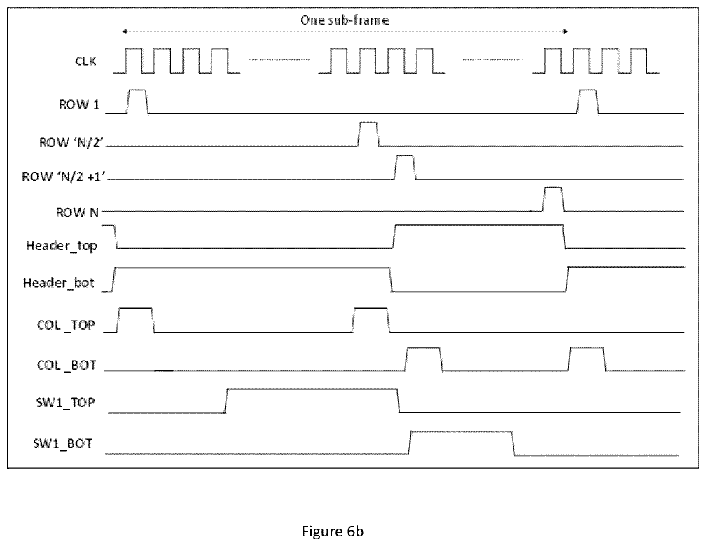

Turning to FIG. 6a, another embodiment of a display including a power consumption reduction apparatus is shown. In the current embodiment, the power consumption reduction apparatus is implemented via a dual column line data driver with column segmentation scheme methodology or embodiment. In this embodiment, each data or column line is divided into two halves or segments driven by two column drivers i.e., top and bottom column drivers. Furthermore, each half of each column line is further divided into plurality of segments connected by column line switches, such as, but not limited to, NMOS switches.

The N*M AMOLED display 600 includes a first data line driver 602 that includes a first shift register 604 and a first hold register 606 that drive a first set of data, or column, lines 608 and a second data line driver 610 that includes a second shift register 612 and a second hold register 614 that drive a second set of data, or column, lines 616. The display 600 further includes a row driver 618 for driving the row lines 620. The display 600 further includes a set or array of pixels 622 that are associated with an intersection between a row line 620 and each data line in the first set of data lines 608 or the second set of data lines 616. The display further includes a pair of column line control switches 624 that control or drive each of the data drivers. The pair of column line control switches 624 are connected to a signal generator 626 that generates the signals necessary to operate the display 600. The timing diagram for display 600 of FIG. 6a is shown in FIG. 6b.

The top and bottom half sections of the column lines are further divided into equal segments 628 of rows and are represented as Seg_1_TOP, Seg_2_BOT, Seg_1_BOT and Seg_2_BOT. It is understood that the top and bottom halves may be divided into a different number of segments, however, the number of segments should be the same for both the top and bottom halves. In the current embodiment, the two top segments are connected via a set of top column line switches 630 and the two bottom segments are connected via a set of bottom column line switches 632. Examples of switches that can be used are NMOS switches.

During scanning of rows “ROW_1” to “ROW_N/2”, the top column driver 602 is activated thereby driving only top half of each the column line. On the other hand, while scanning rows from “ROW_((N/2)+1)” to “ROW_N”, the bottom column driver 610 is activated thereby driving the bottom half of the column lines. To save the static power, the PMOS switches 624 are used and are controlled by “header_top” and “header_bot” signals generated by the signal generator 626 for the top and bottom column line drivers, respectively. If a row line in the top half is accessed, the bottom PMOS switches are turned off which saves or reduces static leakage from bottom column line drivers, bottom hold registers and bottom shift registers. Similarly, if a row lines in the bottom half is accessed, the top PMOS switches are turned off which saves or reduces static leakage from top column line drivers, top hold registers and top shift registers.

As the row scan starts from the first row, all top column line NMOS switches are off initially. Therefore, during scanning of rows in first segment, only capacitance associated with the first segment (Seg_1) in the top half is charged/discharged. The switch SW1_TOP is enabled only after the rows in the first segment (Seg_1_TOP) are completely scanned. During the scanning of segment 2 (Seg_2_TOP), switches SW1_TOP 630 is turned on. This procedure repeats for entire row scans in the top half during a sub-frame time in the display.

During the scanning of row “ROW_((N/2)+1)”, the bottom column drivers are accessed and all of the NMOS switches 632 in the bottom half are turned on. The switch SW1_BOT 632 is disabled only after the rows in the first segment (Seg_2_BOT) in the bottom half is completely scanned.

The dynamic power of a column driver is directly proportional to the column capacitance it is charging/discharging. As the effective capacitance for each segment is smaller than whole column capacitance, this results in a reduction in the dynamic power consumption of column driver.

Testing for the display of FIG. 6a was simulated on a VGA display in TSMC 65 nm technology with a refresh rate of 60 Hz and the PWM driving method. Considering the power consumption needed to generate the controlling signals for this technique or embodiment, the overall dynamic power consumption of the column driver was reduced by 46.55% on average for different test images with respect to conventional display. The average backplane dynamic power consumption for different test images using dual column with column segmentation scheme was reduced by 17.25% with respect to a conventional display.

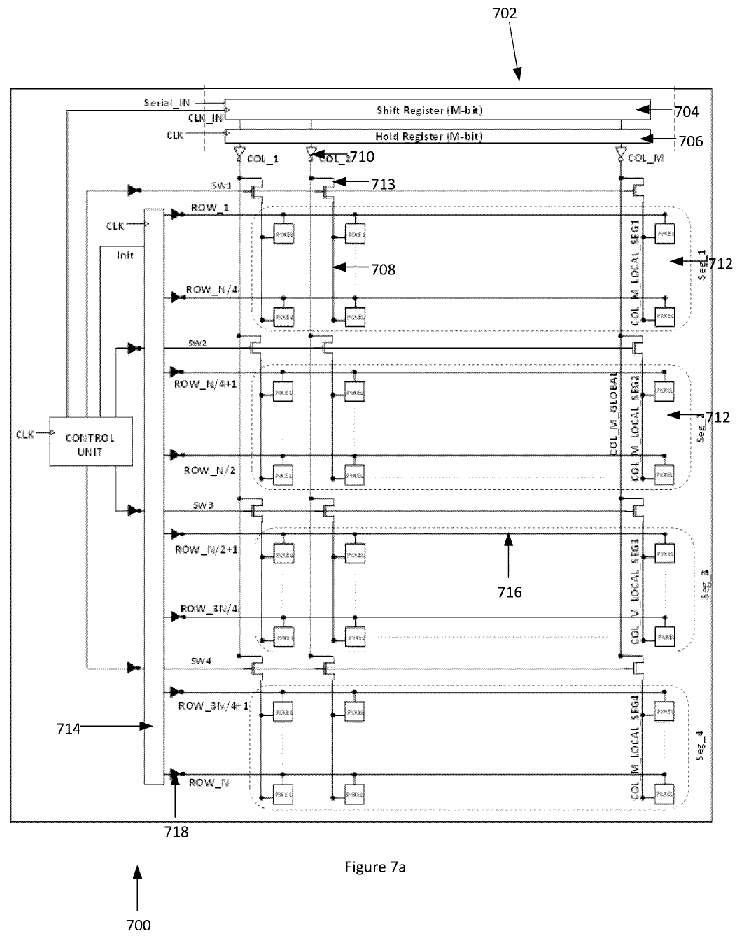

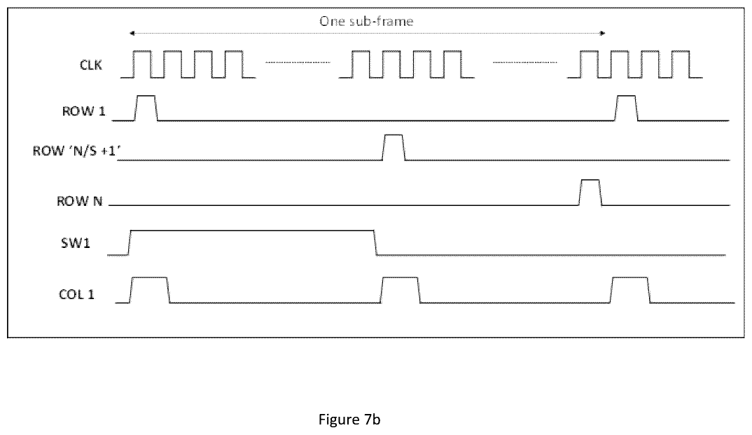

Turning to FIG. 7a, a schematic diagram of another embodiment of a display with a power consumption reduction apparatus is shown. The power consumption reduction apparatus of FIG. 7a may be seen as being implemented via a global-local column line segmentation methodology or embodiment. In this embodiment, each column line is divided into “S” equal segments that are connected by a switch, such as, but not limited to, a NMOS switch, to a global column line. The local column is connected to the sources of the NMOS switches in pixels 120 (NMOS for VGA display with 4 local segments). As such. the capacitance is due to metal capacitance and capacitance associated with the source of NMOS whereby the capacitance of the global column line is associated with the metal capacitance only. Therefore, it is much smaller than local segment column line capacitance.

The display 700 includes a column driver 702 which includes a data line shift register 704 and a data line hold register 706, both of size M, for driving a set of data, or column, lines 708. A set of data line buffers 710, with one data line buffer 710 associated with one of the set of data lines 708, is responsible to charge and discharge each of the data lines 708 with proper data values. Each of the data lines 708 is divided into segments 712, which in the current embodiment is four, with each segment including the same number of rows. Each of the segments 712 are connected to another segment and to a global data line 730 via a set of global line and column line segment connector switches 713 (SW1, SW2, SW3 and SW4).

The display 700 further includes a row driver 714 including a row line shift register that enables a set of rows 716, one row at a time, via a set of row buffers 718. In one embodiment, one of the set of row buffers 718 is associated with one of the set of rows 716.

The timing diagram for the display of FIG. 7a is shown in FIG. 7b. When the rows in the first segment (Seg_1) are accessed, only SW1 713 is turned on. Similarly, when the rows in the second segment (Seg_2) are accessed, only SW2 is turned on, and so on. The dynamic power of column driver is directly proportional to the column capacitance it is charging/discharging. As the column line is segmented, the effective capacitance that is charged/discharged is a sum of local segment column line capacitance and global column line capacitance, which is smaller than total capacitance in a column line, therefore dynamic power consumption of column line drivers is reduced.

Testing for the display of FIG. 7a was simulated on a VGA display in TSMC 65 nm technology with a refresh rate of 60 Hz and the PWM driving method. Considering the power consumption needed to generate the controlling signals for this technique, the overall dynamic power consumption of the column driver was reduced by 17.2% on average for different test images. The average backplane dynamic power consumption for different test images using global-local column line segmentation scheme was reduced by 6.4% with respect to a conventional display.

Table 1 shows results from testing:

TABLE 1
Average dynamic power consumption saving of proposed design's
backplane (row driver, column line driver, SRAM cell, control circuit)
for different test images with respect to conventional displays.

| | Avg. backplane |
|---|---|
| | Dynamic |
| DESIGN | Power Saving |
| Column line segmentation scheme | 8.95% |
| Dual Column line Driver scheme | 13.38% |
| Dual Column line and Row line Drivers scheme | 13.17% |
| Dual Column line Driver with column segmentation | 17.25% |
| scheme | |
| Global-Local column line segmentation scheme | 6.4% |

Further experiments were performed with fabricated test-chips and functionality of the above circuits tested with respect to dynamic power consumption. Table 2 below shows the dynamic power consumption saving of column drivers in these architectures as a proof of the disclosure's improvement over the conventional one for a VGA display and refresh rate at 30 Hz. Testing was performed at 30 Hz instead of 60 Hz because of limitation of testing setup.

TABLE 2
Test-chip average column driver dynamic power consumption saving of
proposed design for different test images with respect to
conventional displays for VGA display and refresh rate of 30 Hz.

| | Avg. column |
|---|---|
| | Dynamic Power |
| DESIGN | Saving |
| Dual Column line Driver with column | 29.3% |
| segmentation scheme | |

The current disclosure may be beneficial when implemented within different displays, such as, but not limited to, a Portable display, a low-power display, a microdisplay; an AMOLED display; an OLEDoS display; a microLED display; cache memory or dual port memory.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

Applicants reserve the right to pursue any embodiments or sub-embodiments disclosed in this application; to claim any part, portion, element and/or combination thereof of the disclosed embodiments, including the right to disclaim any part, portion, element and/or combination thereof of the disclosed embodiments; or to replace any part, portion, element and/or combination thereof of the disclosed embodiments.

The above-described embodiments are intended to be examples only. Alterations, modifications and variations can be effected to the particular embodiments by those of skill in the art without departing from the scope, which is defined solely by the claims appended hereto.

What is claimed is:

1. An electronics component having N row lines and M column lines comprising:
at least one column driver for driving the M column lines; and
at least one row driver for driving the N row lines, wherein the N rows are segmented into a set of column line segments for each of the M column lines;
each of the column line segments including an equal number of rows.

2. The electronics component of claim 1 wherein each of the column line segments in a column line is connected to at least one other column line segment via a column line segment connector switch.

3. The electronics component of claim 1 further comprising:
two column drivers for driving two column line segments wherein the column line segments each include N/2 row lines.

4. The electronics component of claim 3 further comprising two column segment switches, each switch associated with one of the two column drivers.

5. The electronics component of claim 3 comprising:
two sets of row drivers, each of the two sets of row drivers driving the rows in one of the two column line segments.

6. The electronics component of claim 3 wherein the component is a two-port memory cell.

7. The electronics component of claim 6 further comprising a set of SRAM cells connected to each intersection between a row line and a pair of column lines.

8. The electronics component of claim 7 wherein the at least one column driver comprises:
a combination multiplexor and sense amplifier.

9. The electronics component of claim 3 wherein each of the two column line segments are further separated into a set of smaller column line segments.

10. The electronics component of claim 9 wherein each of the set of smaller column line segments are connected to each other via a set of column line segment connector switches.

11. The electronics component of claim 10 further comprising a pair of column line control switches, each of the column line control switches connected to one of the two column line segments.

12. The electronics component of claim 1 further comprising:
a global column line; and
a set of global line column line connector connecting each of the column line segments to each other and to the global column line.

13. The electronics component of claim 1 wherein the at least one column line driver comprises:
a column line shift register; and
a column line hold register.

14. The electronics component of claim 1 wherein the at least one row driver comprises a row shift register.

15. The electronics component of claim 1 wherein the component is an AMOLED display.

16. The electronics component of claim 15 further comprising a set of pixels connected to each intersection between a row line and a column line.
